(19) United States
(12) Patent Application Publication
(10) Pub. No.: US 2005/0147540 A1
(43) Pub. Date: Jul. 7, 2005

(54) Flame-free aromatherapy essence catalyzing core

(76) Inventor: Shu-Li Huang, Taipei (TW)

Correspondence Address: Sathelyne Ltd., P. O. Box No. 6-57, Junghe, Taipei, 235, TW

(21) Appl. No.: 10/751,967

(22) Filed: Jan. 7, 2004

(51) Int. Cl. A62B 7/08

(52) U.S. Cl. 422/125

(57) ABSTRACT

A flame-free aromatherapy essence catalyzing core includes a ceramic seat and an iron net tray. The invention is characterized that, the iron net tray is placed at an upper surface of the ceramic seat, and is filled with a tuft of platinum flameproof cotton thereon; and the ceramic seat is provided with a ceramic protection loop and a fastening apparatus for fixing the iron net tray and the platinum flameproof cotton to the upper surface of the ceramic seat. According to the aforesaid structure, the iron net tray and the platinum flameproof cotton effectively shield conductance of flammable objects and flames, and a flame-free heater is utilized to provide an essence with an appropriate temperature for evaporation. For that a dead flame instead of a live flame is adopted for producing medium combustion, explosion hazards are prevented and thereby obtaining a better overall safety.

### BACKGROUND OF THE INVENTION

(a) Field of the Invention

The invention relates to a flame-free aromatherapy essence catalyzing core, and more particularly, to a structure capable of aerosolizing essence particles without requiring direct contact with a flame, thereby eliminating potential explosions caused by igniting an aromatherapy essence ceramic core using a flame.

(b) Description of the Prior Art

A so-called aromatherapy essence is a volatile and highly concentrated fragrant object. Using various chemical or physical means, an aromatherapy essence is extracted from roots, stems, leaves, seeds or blossoms of plants, and is commonly referred to as a unilateral essence. Due to immense work stress nowadays, aromatherapy essences are frequently used by modern people in order to clear one's mind for focusing concentration, or to relax and relieve oneself from anxiety for further putting one to better sleep.

It is known that an aromatherapy essence is insoluble in water substances but soluble in alcoholic substances. Therefore, an isopropyl alcohol is generally selected as a solvent thereof. Yet, isopropyl alcohols have low combustion points and are also highly volatile, and thus become inflammable gases when vaporized. Referring to FIG. 1, a mixture solute from an aromatherapy essence 3 and an isopropyl alcohol is placed in an aromatherapy essence bottle 4. The aromatherapy essence bottle 4 is arranged with a lamp core 5 at an interior thereof, wherein a portion of the core 5 is dipped in the aromatherapy essence 3. The aromatherapy essence bottle 4 also has an aromatherapy essence ceramic core 6 at a bottle opening thereof. The aromatherapy essence ceramic core 6 is joined with one end of the lamp core 5. Using capillarity of the lamp core 5, the aromatherapy essence 3 in the aromatherapy essence bottle 4 is ascended to reach the aromatherapy essence ceramic core 6. Because the aromatherapy essence ceramic core 6 is made of a porous ceramic material formed by particles having spaces in between, the aromatherapy essence ceramic core 6 is provided with good permeability and absorbability, and hence spaces within the aromatherapy essence ceramic core 6 easily become filled with the aromatherapy essence 3. A flame is utilized to ignite the aromatherapy essence ceramic core 6 at the aromatherapy essence bottle 4, so as to burn the isopropyl alcohol contained in the aromatherapy essence 3. The flame at a surface of the ceramic core 6 is put out when the aromatherapy essence ceramic core 6 is heated up by the flame, such that the isopropyl alcohol is burned at small quantities within minute spaces within the ceramic core 6. The aromatherapy essence 3 is vaporized into air through the aromatherapy essence ceramic core 6 having a high temperature.

However, during combustion, the ascended aromatherapy essence 3 along the lamp core 5 may add up to an excessive amount, and become rapidly vaporized and burned. Thus, accidental explosions are often resulted from pressure unbalance regarding in and out of the aromatherapy essence bottle 4.

In addition, for that the prior ceramic core 6 and the lamp core 5 lack other medium in between, the aromatherapy essence 3 is quickly ascended to minute spaces within the ceramic core 6 along the lamp core 5, so that the minute spaces within the ceramic core 6 are filled with over-concentrated aromatherapy essence 6 and flammable gases. At this point, supposed a lighter is utilized to directly ignite the ceramic core 6, it is highly possible that a flame burns strongly with the over-concentrated aromatherapy essence 3 and the flammable gases. The flame may immediately burn along the lamp core 5 to reach an interior of the aromatherapy essence bottle 4, and further cause explosion from rapidly burning the aromatherapy essence 3 in the aromatherapy essence bottle 4.

### SUMMARY OF THE INVENTION

In the view of the aforesaid shortcomings of the prior aromatherapy essence ceramic core ignited using a flame, the primary object of the invention is to provide an aromatherapy essence catalyzing core capable of aerosolizing essence particles without direct contact with a flame, thereby eliminating potential explosion hazards caused by igniting an aromatherapy essence ceramic core with a flame.

To accomplish the aforesaid object, a flame-free aromatherapy essence catalyzing core comprises a ceramic seat and an iron net tray. The invention is characterized that, the iron net tray is placed at an upper surface of the ceramic seat, and is filled with a tuft of platinum flameproof cotton thereon; and the ceramic seat is provided with a ceramic protection loop and a fastening apparatus for fixing the iron net tray and the platinum flameproof cotton to the upper surface of the ceramic seat. According to the aforesaid structure, the iron net tray and the platinum flameproof cotton effectively shield conductance of flammable objects and flames, and a flame-free heater is utilized to provide an essence with an appropriate temperature for evaporation. For that a dead flame instead of a live flame is adopted for producing medium combustion, explosion hazards are prevented and thereby obtaining a better overall safety.

### BRIEF DESCRIPTION OF THE DRAWINGS

FIG. 1 shows an application example of an aromatherapy essence ceramic core of a prior art.

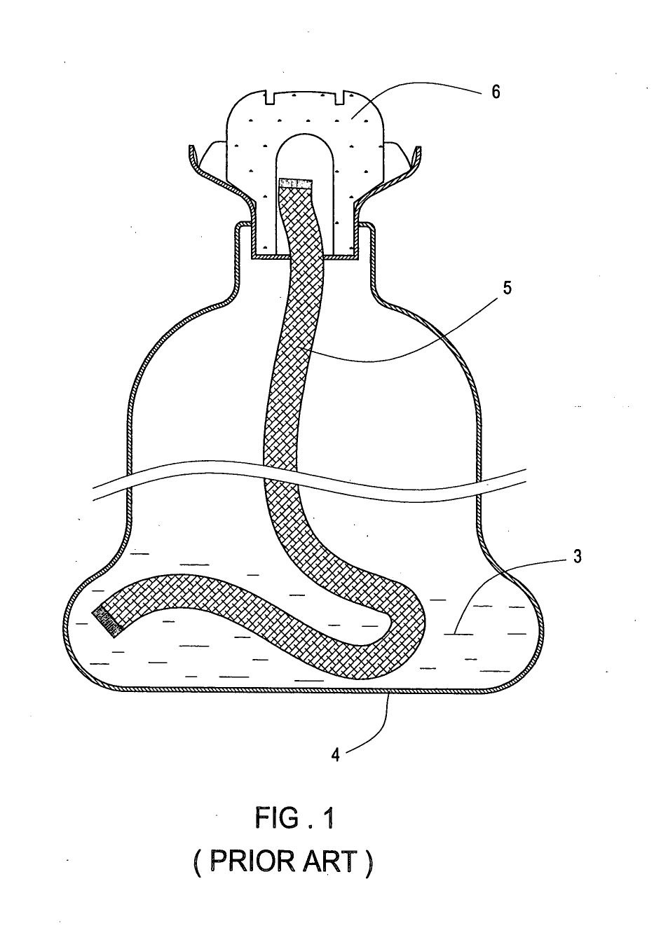

FIG. 2 shows an exploded elevational view according to the invention.

FIG. 3 shows an elevational view according to the invention.

FIG. 4 shows a schematic view illustrating an embodiment according to the invention.

### DETAILED DESCRIPTION OF THE PREFERRED EMBODIMENTS

To better understand structures, devices and characteristics of the invention, detailed descriptions of a preferred embodiment shall be given with the accompanying drawings below.

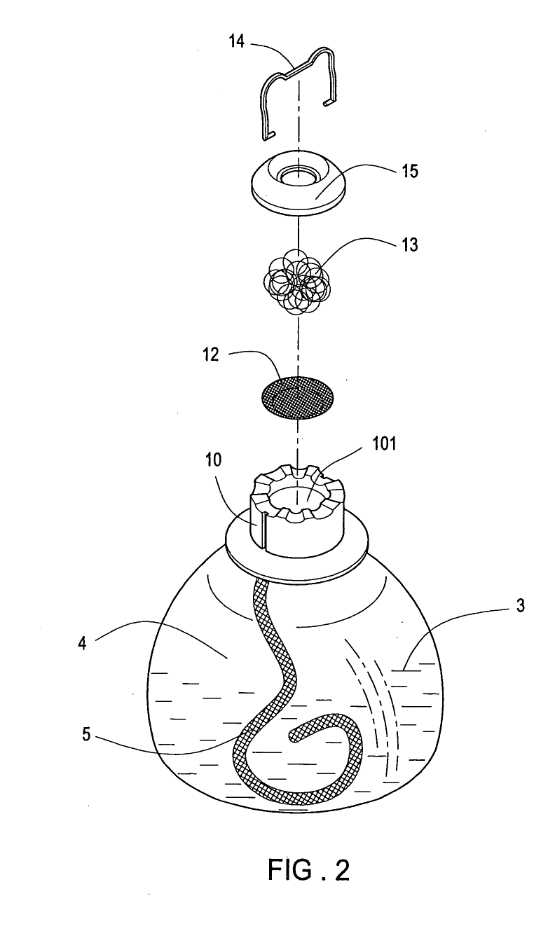

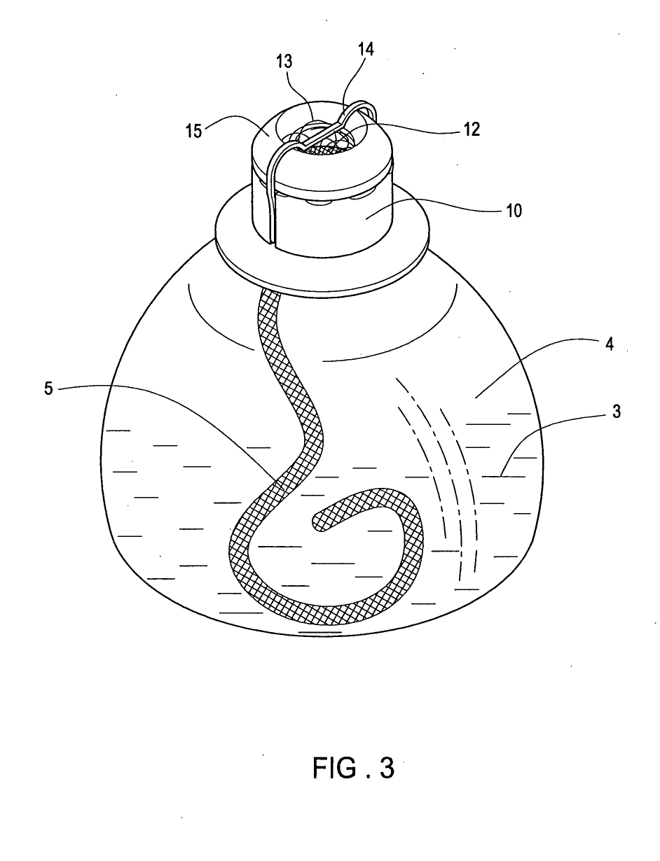

Referring to FIGS. 2 and 3, a flame-free aromatherapy essence catalyzing core comprises a ceramic seat 10 and an iron net tray 12. The ceramic seat 10 is disposed at an opening of an aromatherapy essence bottle 4, and has a lower portion thereof joined with one end of a lamp core 5.

The invention is characterized that, the ceramic seat 10 is made of a porous ceramic material, and is formed with a recess 101 at an upper surface thereof; the recess 101 is spread with the iron net tray 12 placed and filled with a tuft of platinum flameproof cotton 13 thereon; the ceramic seat 10 is also provided with a ceramic protection loop 15 and a fastening apparatus 14 for fixing the iron net tray 12 and the platinum flameproof cotton 13 to the upper surface of the ceramic seat 10.

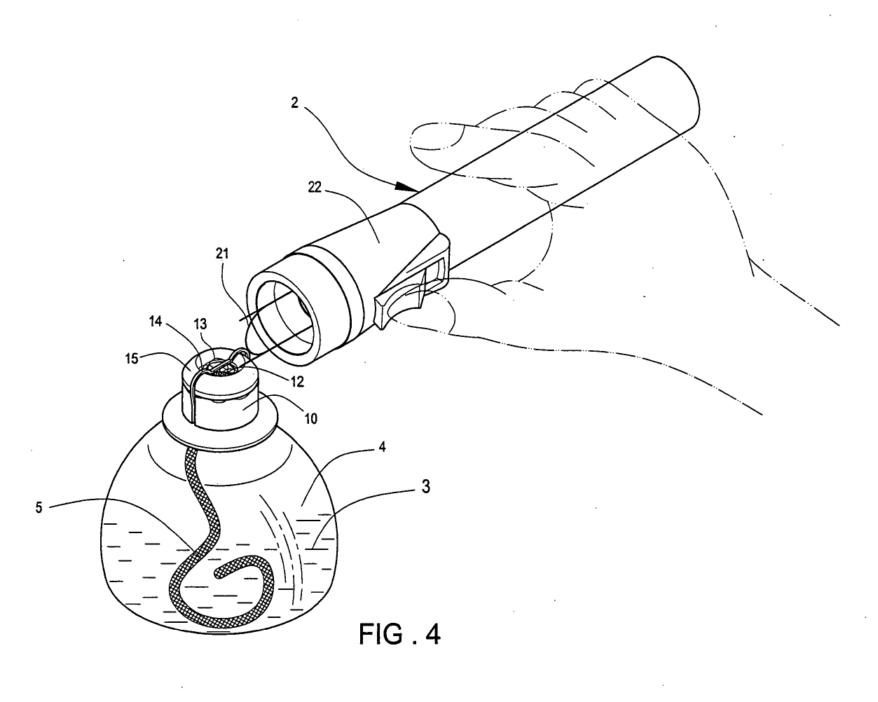

Referring to FIG. 4, the flame-free aromatherapy essence catalyzing core is indirectly heated using a flame-free heater 2. The flame-free heat 2 is a tubular structure 22, which has an electrothermal filament 21 at a front end thereof and electric cells at an interior thereof for supplying the electrothermal filament 21 with heating power. A user may directly heat the platinum flameproof cotton 13 using the electrothermal filament 21, wherein the platinum flameproof cotton 13 is refractory up to 400 to 500 degree Celsius. A temperature of the electrothermal filament 21 is conducted to the ceramic seat 10 via the platinum flameproof cotton 13 and the iron net tray 12. Thus, an aromatherapy essence 3 contained in pores of the ceramic seat 10 begins to gradually burn due of the raising temperature. When the user smells that gases of the aromatherapy essence are largely liberated, a heating switch of the flame-free heater 2 is switched off, and the electrothermal filament 21 is removed from the platinum flameproof cotton 13 to complete an entire heating process.

According to the aforesaid structure, the iron net tray 12 blocks direct conductance of the aromatherapy essence 3 at the platinum flameproof cotton 13 and the ceramic seat 10, and the platinum flameproof cotton 13 is also prevented from absorbing the aromatherapy essence 3, thereby prohibiting combustions of the aromatherapy essence 3 or over-concentrated flammable gases at the platinum flameproof cotton 13 during the heating process.

In addition, the platinum flameproof cotton 13 serves the ceramic seat 10 as a conducting medium during the heating process using a dead flame instead of a live flame, and thus an overall safety can be accounted. Supposed the platinum flameproof cotton 13 is burned from contaminated with the aromatherapy essence 3 or flammable gases, the flame produced is shielded by the platinum flameproof cotton 13. Consequently, the flame at the platinum flameproof cotton 13 does not directly reach the ceramic seat 10 while also evenly distributing a heated temperature to the ceramic seat 10. The aromatherapy essence 3 is enabled to achieve an appropriate burning temperature, so that volatile particles thereof become even smaller for better permeation and aromatizing effects.

Moreover, in the flame-free aromatherapy essence catalyzing core according to the invention, a high temperature of the electrothermal filament 21 is produced using electric power of internal electric cells of the flame-free heater 2. Hence, it is unlikely that flammable gases around the core are quickly burned by the high-temperature electrothermal filament 21 core that does not produce a flame. As a result, the aromatherapy essence 3 is prevented from rapid evaporation and combustion, such that not only pressures regarding in and out of the aromatherapy essence bottle 4 are well-controlled and balanced, but also flames are prohibited from burning into the aromatherapy essence bottle for accomplishing enhanced safety.

It is of course to be understood that the embodiment described herein is merely illustrative of the principles of the invention and that a wide variety of modifications thereto may be effected by persons skilled in the art without departing from the spirit and scope of the invention as set forth in the following claims.

1. A flame-free aromatherapy essence catalyzing core comprising a ceramic seat and an iron net tray; wherein, the ceramic seat is disposed at an opening of an aromatherapy essence bottle, and has a lower portion thereof joined with one end of a lamp core; and being characterized that, the ceramic seat is made of a porous ceramic material, and is formed with a recess at an upper surface thereof; the recess is spread with the iron net tray placed and filled with a tuft of platinum flameproof cotton thereon; the ceramic seat is also provided with a ceramic protection loop and a fastening apparatus for fixing the iron net tray and the platinum flameproof cotton to the upper surface of the ceramic seat; and the flame-free aromatherapy essence catalyzing core is indirectly heated by heating the platinum flameproof cotton using a flame-free heater.

2. The flame-free aromatherapy essence catalyzing core in accordance with claim 1, wherein the flame-free heat is a tubular structure, which has an electrothermal filament at a front end thereof and electric cells at an interior thereof for supplying the electrothermal filament with heating power.
